(19) United States
(12) Patent Application Publication
(10) Pub. No.: US 2013/0169516 A1
(43) Pub. Date: Jul. 4, 2013

(54) PIXEL CIRCUIT, DISPLAY APPARATUS AND DRIVING METHOD

(71) Applicants: Lien-Hsiang CHEN, Miao-Li County (TW); Kung-Chen Kuo, Miao-Li County (TW); Ming-Chun Tseng, Miao-Li County (TW)

(72) Inventors: Lien-Hsiang CHEN, Miao-Li County (TW); Kung-Chen Kuo, Miao-Li County (TW); Ming-Chun Tseng, Miao-Li County (TW)

(21) Appl. No.: 13/618,119

(22) Filed: Sep. 14, 2012

(30) Foreign Application Priority Data
Dec. 28, 2011 (TW) 100149180

(51) Int. Cl. G09G 3/32

(52) U.S. Cl. 345/76

(57) ABSTRACT

A pixel circuit includes an energy storage element, a driving transistor, a first transistor and a second transistor. The driving transistor has a gate electrically connected with the energy storage element. The first transistor has a first terminal electrically connected with the energy storage element and the gate of the driving transistor, and a second terminal electrically connected with the first terminal of the driving transistor. The second transistor has a first terminal electrically connected with the first terminal of the driving transistor and the second terminal of the first transistor, and a second terminal connected with a data voltage or a first voltage. During a first stage, the gates of the first and second transistors receive a first signal and a second signal, respectively, and the data voltage or the first voltage charges the energy storage element via the first and second transistors.

### CROSS REFERENCE TO RELATED APPLICATIONS

This Non-provisional application claims priority under 35 U.S.C. §119(a) on Patent Application No(s). 100149180 filed in Taiwan, Republic of China on Dec. 28, 2011, the entire contents of which are hereby incorporated by reference.

### BACKGROUND OF THE INVENTION

1. Field of Invention

The invention relates to a pixel circuit, a display apparatus and a driving method, and in particular, to a pixel circuit of an organic light-emitting diode, a display apparatus and a driving method.

2. Related Art

A flat display apparatus has been used in various electronic products and gradually replaces a conventional cathode ray tube (CRT) display apparatus due to its advantages including the low power consumption, the low generated heat, the light weight and the non-radiative property. The flat display apparatuses may be classified into a passive matrix type and an active matrix type according to the driving mode thereof. Due to the restriction of the driving mode, the passive matrix display apparatus has the shorter lifetime and cannot be made to have a larger area. Although the active matrix display apparatus has the drawbacks of the higher cost and the more complicated manufacturing processes, it is adapted to the large-size, high-resolution full colorization display with the high information capacity, and therefore becomes the mainstream of the flat display apparatus, wherein an active organic light-emitting diode (OLED) display apparatus is one of the main products that are recently developed.

However, in the conventional thin film transistor applied to the manufacturing of the active OLED display apparatus, the driving transistors for driving the OLEDs may cause the shifts of the threshold voltages (Vth) of the transistors due to the factors, such as different materials, different element properties or the like, so that the driving currents of the OLEDs of the pixels have slight differences therebetween under the driving of the same data voltage, thereby indirectly causing the phenomenon (e.g., Mura) of the nonuniform brightness of the display frame of the OLED display apparatus.

In order to improve the above-mentioned phenomenon, the prior art also discloses a pixel compensating circuit and a driving method thereof for compensating the phenomenon of the nonuniform brightness of the frame caused by the shift of the threshold voltage Vth of the driving transistor.

FIG. 1 is a schematic illustration showing a conventional pixel circuit P. As shown in FIG. 1, a pixel circuit P can solve the phenomenon of the nonuniform brightness of the display frame caused by the shift of the threshold voltage Vth of the driving transistor. The pixel circuit P includes six transistors T1 to T6, a capacitor Cst and an organic light-emitting diode OLED. The transistor T4 is a driving transistor for driving the organic light-emitting diode OLED, and the pixel circuit P is the so-called 6T1C pixel circuit. Because the pixel circuit P pertains to the prior art the connection relationships between the elements have been shown in FIG. 1 and the driving processes of the pixel circuit P also pertain to the prior art, people who are interested in these can refer to the prior art data, and detailed descriptions thereof will be omitted.

The pixel circuit P and the driving method thereof can compensate the threshold voltage Vth of the driving transistor T4, and thus improve the problem of the nonuniform brightness caused by the variation of the element property of the driving transistor of the OLED display apparatus.

However, in order to compensate the threshold voltage Vth of the driving transistor T4, four signal lines (i.e., for the signals INI, S1, S2 and Eₙ in FIG. 1) and the six transistors T1 to T6 have to be used to achieve the effect of compensating the shift of the threshold voltage Vth during the layout of the pixel circuit P, thereby reducing the aperture ratio of the display apparatus. In addition, when the aperture ratio is reduced, the organic light-emitting diode OLED of each pixel circuit P is required to output the stronger light in order to make the display apparatus have the same display effect (i.e., the same display brightness), thereby shortening the lifetime of the organic light-emitting diode OLED.

Therefore, it is an important subject to provide a pixel circuit, a display apparatus and a driving method capable of improving the problem of the nonuniform brightness caused by the variation of the element property of the driving transistor of the display apparatus, and further increasing the aperture ratio of the display apparatus.

### SUMMARY OF THE INVENTION

In view of the foregoing subject, an objective of the invention is to provide a pixel circuit, a display apparatus and a driving method capable of improving the problem of the nonuniform brightness caused by the variation of the element property of the driving transistor of the display apparatus, and further increasing the aperture ratio of the display apparatus.

To achieve the above objective, the present invention discloses a pixel circuit including an energy storage element, a driving transistor, a first transistor, and a second transistor. The gate of the driving transistor is electrically connected with the energy storage element. A first terminal of the first transistor is electrically connected with the energy storage element and the gate of the driving transistor, and a second terminal of the first transistor is electrically connected with a first terminal of the driving transistor. A first terminal of the second transistor is electrically connected with the first terminal of the driving transistor and the second terminal of the first transistor, and a second terminal of the second transistor is connected with a data voltage or a first voltage. During a first stage, the gates of the first transistor and the second transistor receive a first signal and a second signal, respectively, and the data voltage or the first voltage charges the energy storage element via the first transistor and the second transistor.

To achieve the above objective, the present invention also discloses a pixel circuit including an energy storage element, a driving transistor, a first transistor, and a second transistor. The driving transistor has a gate electrically connected with the energy storage element. A first terminal of the first transistor is electrically connected with the energy storage element and the gate of the driving transistor, and a second terminal of the first transistor is connected with a first voltage. A first terminal of the second transistor is electrically connected with a first terminal of the driving transistor, and a second terminal of the second transistor is connected with the second terminal of the first transistor and the first voltage. During a first stage, a gate of the first transistor receives a first signal, and the first voltage charges the energy storage element via the first transistor.

To achieve the above objective, the present invention discloses a display apparatus, which comprises a driving circuit and at least one pixel circuit. The driving circuit has at least one scan line and at least one data line and at least outputs a data voltage, a first signal and a second signal. The pixel circuit has an energy storage element, a driving transistor, a first transistor and a second transistor. A gate of the driving transistor is electrically connected with one terminal of the energy storage element. A first terminal of the first transistor is electrically connected with the terminal of the energy storage element and the gate of the driving transistor, and a second terminal of the first transistor is electrically connected with a first terminal of the driving transistor. A first terminal of the second transistor is electrically connected with the first terminal of the driving transistor and the second terminal of the first transistor, and a second terminal of the second transistor is connected with the data voltage or a first voltage. During a first stage, the gates of the first transistor and the second transistor receive the first signal and the second signal, respectively, so that the data voltage or the first voltage charges the energy storage element via the first transistor and the second transistor.

To achieve the above objective, the present invention discloses a display apparatus, which comprises a driving circuit and at least one pixel circuit. The driving circuit has at least one scan line and at least one data line and at least outputs a data voltage, a first signal and a second signal. The pixel circuit includes an energy storage element, a driving transistor, a first transistor, and a second transistor. The driving transistor has a gate electrically connected with the energy storage element. A first terminal of the first transistor is electrically connected with the energy storage element and the gate of the driving transistor, and a second terminal of the first transistor is connected with a first voltage. A first terminal of the second transistor is electrically connected with a first terminal of the driving transistor, and a second terminal of the second transistor is connected with the second terminal of the first transistor and the first voltage. During a first stage, a gate of the first transistor receives a first signal, and the first voltage charges the energy storage element via the first transistor.

To achieve the above objective, the present invention discloses a driving method applied with a display apparatus, which comprises a driving circuit and at least one pixel circuit. The driving circuit has at least one scan line and at least one data line and at least outputs a data voltage, a first signal and a second signal. The first signal and the second signal are scan signals outputted from the scan line, respectively. The pixel circuit has an energy storage element, a driving transistor, a first transistor and a second transistor. A gate of the driving transistor is electrically connected with one terminal of the energy storage element. A first terminal of the first transistor is electrically connected with the terminal of the energy storage element and the gate of the driving transistor, and a second terminal of the first transistor is electrically connected with a first terminal of the driving transistor. A first terminal of the second transistor is electrically connected with the first terminal of the driving transistor and the second terminal of the first transistor, and a second terminal of the second transistor is connected with the data voltage or a first voltage. The driving method comprises a step of: receiving the first signal and the second signal via gates of the first transistor and the second transistor, respectively, during a first stage, so that the data voltage or the first voltage charges the energy storage element via the first transistor and the second transistor.

To achieve the above objective, the present invention discloses a driving method applied with a display apparatus, which comprises a driving circuit and at least one pixel circuit. The driving circuit has at least one scan line and at least one data line and at least outputs a data voltage, a first signal and a second signal. The first signal and the second signal are scan signals outputted from the scan line, respectively. The pixel circuit has an energy storage element, a driving transistor, a first transistor and a second transistor. A gate of the driving transistor is electrically connected with one terminal of the energy storage element. A first terminal of the first transistor is electrically connected with the terminal of the energy storage element and the gate of the driving transistor, a second terminal of the first transistor is connected with a first voltage. A first terminal of the second transistor is electrically connected with a first terminal of the driving transistor, and a second terminal of the second transistor is connected with the second terminal of the first transistor and the first voltage. The driving method comprises the step of: receiving the first signal via a gate of the first transistor during a first stage, so that the first voltage charges the energy storage element via the first transistor.

As mentioned above, the pixel circuit, the display apparatus and the driving method of the invention have the following features. During a first stage, the gates of the first transistor and the second transistor receive a first signal and a second signal, respectively, and the data voltage or the first voltage can charge the energy storage element via the first transistor and the second transistor. Alternatively, during a first stage, the gate of the first transistor can receive a first signal, and the first voltage can charge the energy storage element via the first transistor. Therefore, it is possible to make the driving current for driving the organic light-emitting diode of the pixel circuit only relate to the data voltage and the second voltage, but unrelate to the threshold voltage of the driving transistor during the emitting stage (i.e., the displaying stage) of the display apparatus. Consequently, it is possible to improve the problem of the shift of the threshold voltage caused by the factors of the driving transistor of the pixel circuit, such as different manufacturing processes, different materials, different element properties or the like, and to improve the phenomenon of the nonuniform brightness of the display frame of the OLED display apparatus. In addition, compared with the prior art pixel circuit, the number of signal lines or the number of transistors used in the pixel circuit of the invention is smaller than that of the prior art by one, so that the aperture ratio of the display apparatus can be effectively enhanced, and the lifetime of the organic light-emitting diode can be further lengthened.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional pixel circuit;

FIG. 2A is a schematic circuit diagram showing a pixel circuit according to a first embodiment of the invention;

FIGS. 2B to 2D are schematic illustrations showing that the pixel circuit of the first embodiment is driven during different stages, respectively;

FIG. 2E is a schematic illustration showing signals for driving the pixel circuit of the first embodiment;

FIG. 3A is a schematic circuit diagram showing a pixel circuit according to a second embodiment of the invention;

FIGS. 3B to 3D are schematic illustrations showing that the pixel circuit of the second embodiment is driven during different stages, respectively;

FIG. 3E is a schematic illustration showing signals for driving the pixel circuit of the second embodiment;

FIG. 4A is a schematic circuit diagram showing a pixel circuit according to a third embodiment of the invention;

FIGS. 4B to 4D are schematic illustrations showing that the pixel circuit of the third embodiment is driven during different stages, respectively;

FIG. 4E is a schematic illustration showing signals for driving the pixel circuit of the third embodiment;

FIG. 5 is a schematic illustration showing a display apparatus according to a preferred embodiment of the invention; and

FIGS. 6 to 8 are schematic flow charts showing different driving methods of the invention, respectively.

### DETAILED DESCRIPTION OF THE INVENTION

The present invention will be apparent from the following detailed description, which proceeds with reference to the accompanying drawings, wherein the same references relate to the same elements.

### First Embodiment

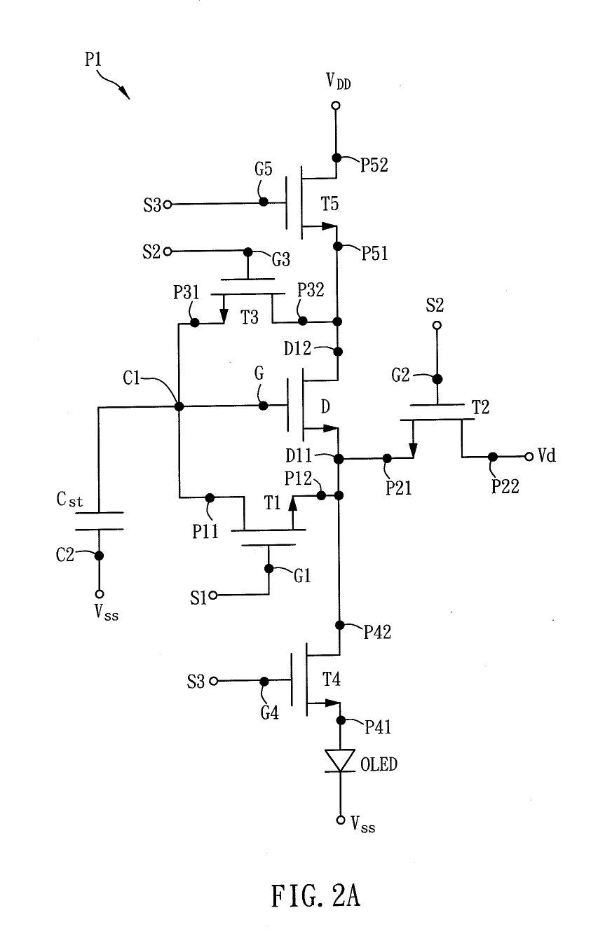

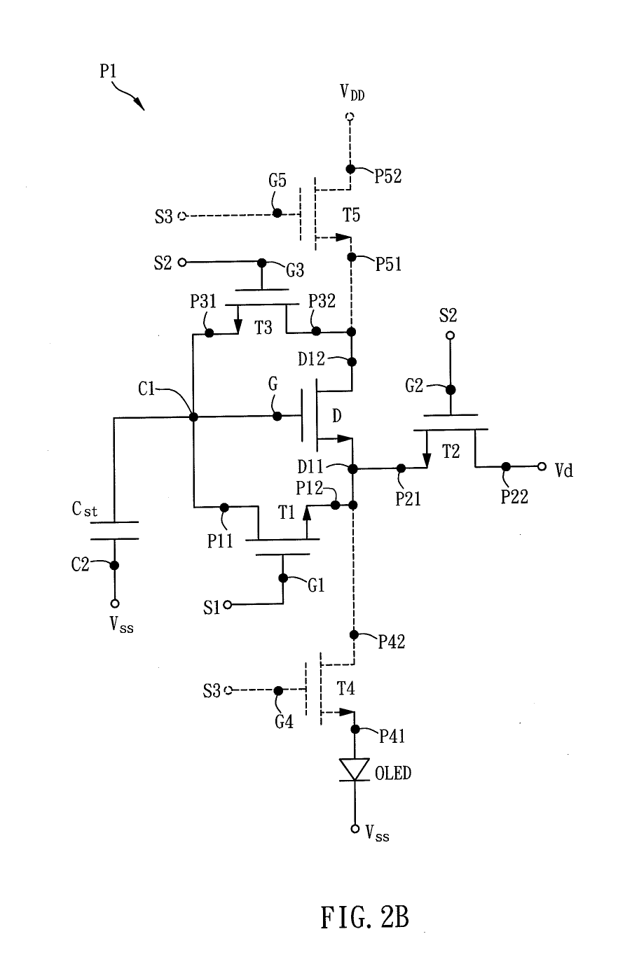

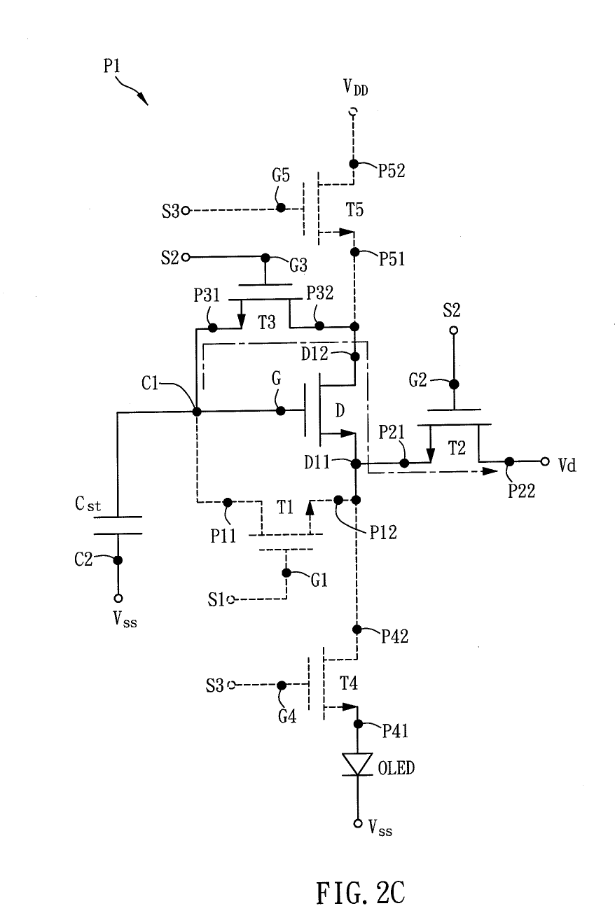

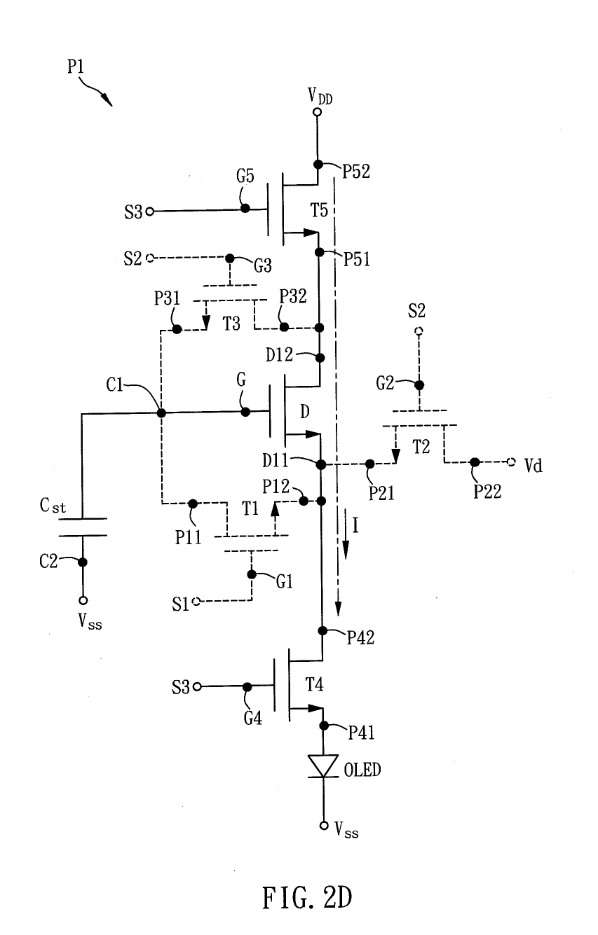

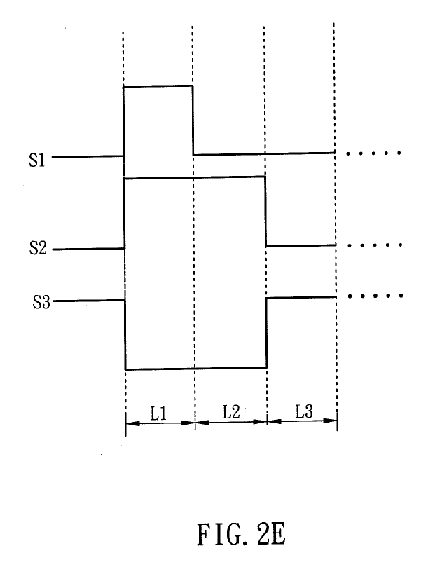

FIG. 2A is a schematic circuit diagram showing a pixel circuit P1 according to a first embodiment of the invention.

Referring to FIG. 2A, the pixel circuit P1 of the invention includes an energy storage element Cst, a driving transistor D, a first transistor T1 and a second transistor T2. In addition, the pixel circuit P1 further includes a third transistor T3, a fourth transistor T4, a fifth transistor T5 and an organic light-emitting diode OLED.

The gate G of the driving transistor D is electrically connected with the energy storage element Cst. Herein, the energy storage element Cst is a capacitor, and the gate G of the driving transistor D is electrically connected with a terminal C1 of the energy storage element Cst, and the other terminal C2 of the energy storage element Cst is electrically connected with a second voltage V_{SS} terminal (or may also be electrically connected with a first voltage V_{DD} terminal).

The first terminal P11 of the first transistor T1 is electrically connected with the terminal C1 of the energy storage element Cst and the gate G of the driving transistor D, and the second terminal P12 of the first transistor T1 is electrically connected with the first terminal D11 of the driving transistor D. In addition, the first terminal P21 of the second transistor T2 is electrically connected with the first terminal D11 of the driving transistor D and the second terminal P12 of the first transistor T1, and the second terminal P22 of the second transistor T2 is electrically connected with a data voltage Vd terminal. The data voltage Vd may be an output coming from a data driving circuit (not shown).

The first terminal P31 of the third transistor T3 is electrically connected with the terminal C1 of the energy storage element Cst, the gate G of the driving transistor D and the first terminal P11 of the first transistor T1, and the second terminal P32 of the third transistor T3 is electrically connected with the second terminal D12 of the driving transistor D.

The first terminal P41 of the fourth transistor T4 is electrically connected with the anode of the organic light-emitting diode OLED, and the second terminal P42 of the fourth transistor T4 is electrically connected with the first terminal D11 of the driving transistor D, the second terminal P12 of the first transistor T1 and the first terminal P21 of the second transistor T2.

The first terminal P51 of the fifth transistor T5 is electrically connected with the second terminal D12 of the driving transistor D and the second terminal P32 of the third transistor T3, and the second terminal P52 of the fifth transistor T5 is electrically connected with the first voltage V_{DD} terminal. In addition, the cathode of the organic light-emitting diode OLED is electrically connected with the second voltage V_{SS} terminal. The cathode of the organic light-emitting diode OLED and the terminal C2 of the energy storage element Cst may be DC bias voltages (either positive or negative), so the second voltage V_{SS} may be a DC bias voltage.

In this embodiment, the anode of the organic light-emitting diode OLED is electrically connected with the first terminal P41 of the fourth transistor T4, and the cathode thereof is electrically connected with the second voltage V_{SS} terminal. In another aspect, however, the anode of the organic light-emitting diode OLED may also be electrically connected with the first voltage V_{DD} terminal, and its cathode may also be electrically connected with the second terminal P52 of the fifth transistor T5.

In the following, the driving processes of the pixel circuit P1 will be described with reference to FIGS. 2B to 2E, respectively. FIGS. 2B to 2D are schematic illustrations showing that the pixel circuit P1 is driven during different stages, respectively. FIG. 2E is a schematic illustration showing signals for driving the pixel circuit P1. It is to be firstly specified that, in FIGS. 2B to 2D, the transistors indicated by the dashed line portions represent that the transistors are not turned on.

As shown in FIGS. 2B and 2E, during a first stage L1 of driving the pixel circuit P1, the gates G1 and G2 of the first transistor T1 and the second transistor T2 respectively receive a first signal S1 and a second signal S2. Herein, as shown in FIG. 2E, during the first stage L1, the first signal S1 and the second signal S2 are at the high level, so the first transistor T1 and the second transistor T2 can be turned on, as shown by the directions indicated by the dashed line arrows of FIG. 2B. At this time, the data voltage Vd may be a high-level initial voltage, and the high-level data voltage Vd (i.e., the initial voltage) can charge the terminal C1 of the energy storage element Cst via the second transistor T2 and the first transistor T1, so that the terminal C1 of the energy storage element Cst is charged to the high-level data voltage Vd. The first stage L1 may be referred to as a reset stage of the pixel circuit P1, wherein the voltage of the terminal C1 of the energy storage element Cst may be reset in the reset stage. In addition, when the terminal C1 of the energy storage element Cst is charged such that the voltage of the gate G of the driving transistor D is increased to the voltage sufficient to turn on the driving transistor D, the driving transistor D is also turned on.

In addition, as shown in FIGS. 2C and 2E, during a second stage L2, the gates G2 and G3 of the second transistor T2 and the third transistor T3 receive the second signal S2. Herein, as shown in FIG. 2E, during the second stage L2, the second signal S2 is at the high level, as shown by the direction indicated by the dashed line arrow of FIG. 2C, the energy storage element Cst may be discharged via the third transistor T3, the driving transistor D and the second transistor T2 (at this time, the voltage level of the data voltage Vd may be lower). Because the transistor T2 is turned on, the voltage of the first terminal D11 of the driving transistor D may be the same as the data voltage Vd, and the voltage difference between the gate G of the driving transistor D and the second terminal D12 of the driving transistor D is the threshold voltage Vth, the voltage of the terminal C1 of the energy storage element Cst (i.e., the voltage of the gate G of the driving transistor D) will be discharged to Vd+Vth. The second stage L2 may be referred to as a compensation stage of the pixel circuit P1, where the compensation is made to make the voltage level of the gate G of the driving transistor D become Vd+Vth.

In addition, as shown in FIGS. 2D and 2E, during a third stage L3 of driving the pixel circuit P1, the gates G4 and G5 of the fourth transistor T4 and the fifth transistor T5 receive a third signal S3, and the first voltage V_{DD} can drive the organic light-emitting diode OLED to emit light via the fifth transistor T5, the driving transistor D and the fourth transistor T4. Herein, as shown in FIG. 2E, during the third stage L3, the third signal S3 may be at the high level. Thus, the fourth transistor T4 and the fifth transistor T5 may be turned on (because the voltage of the gate G of the driving transistor D is Vd+Vth, the driving transistor D is also turned on), as indicated by the arrow direction of FIG. 2D, and the data voltage V_{DD} can drive the organic light-emitting diode OLED to emit light via the fifth transistor T5, the driving transistor D and the fourth transistor T4. Herein, the third stage L3 may be referred to as an emitting stage of the pixel circuit P1, and also may be referred to as a displaying stage. Because the transistor T4 is turned on, the voltage of the first terminal D11 of the driving transistor D is equal to the second voltage V_{SS} plus the voltage V_OLED1 (V_OLED1 is the voltage drop when the organic light-emitting diode OLED is turned on), and the voltage of the gate G of the driving transistor D is still Vd+Vth of the second stage. So, the voltage difference between the gate G of the driving transistor D and the source (first terminal D11) may be referred to as V_{GS}=Vd+Vth−ΔV, wherein ΔV=(Vss+V_OLED1). It is to be specified that the first signal S1, the second signal S2 and the third signal S3 may be scan signals outputted from a scan driving circuit for driving the display apparatus.

Because the driving current I of the organic light-emitting diode OLED is directly proportional to (V_{GS}−Vth)², the driving current I=K×(V_{GS}−Vth)²=K×(Vd+Vth−ΔV−Vth)²=K×(Vd−Vss−V_OLED1)². Thus, it is found that, during the displaying stage, the driving current I only relates to the data voltage Vd and the second voltage V_{SS}, and unrelates to the threshold voltage Vth. Consequently, it is possible to improve the problem of the shift of the threshold voltage Vth caused by the factors of the driving transistor D of the pixel circuit P1, such as different manufacturing processes, different materials, different element properties or the like, and to improve the phenomenon of the nonuniform brightness of the display frame of the OLED display apparatus.

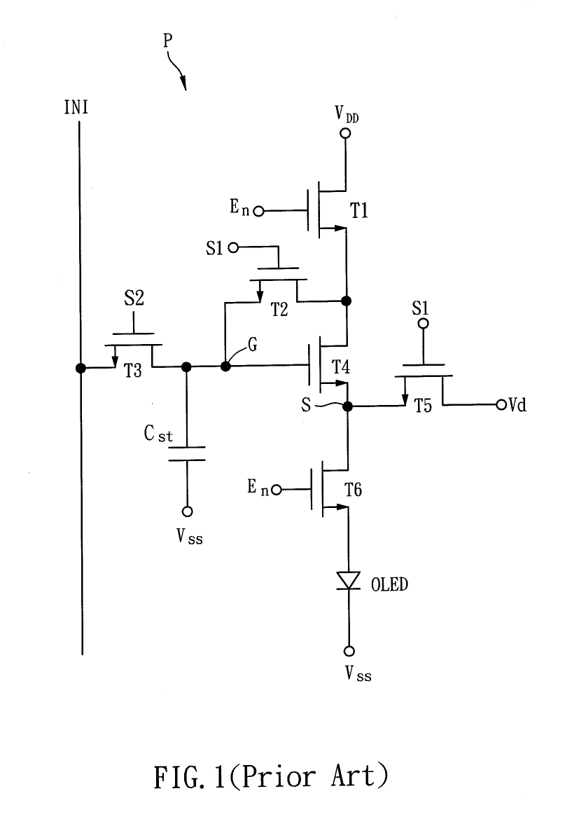

The pixel circuit P1 can improve the problem of the nonuniform brightness of the display frame. In addition, compared with the prior art 6T1C pixel circuit P, which needs to use four signal lines (INI, S1, S2 and Eₙ shown in FIG. 1), the pixel circuit P1 of the invention only needs three signal lines (the lines for the first signal S1, the second signal S2 and the third signal S3), which are fewer than the prior art by one signal line, upon layout. Thus, the aperture ratio of the display apparatus can be effectively increased, and the lifetime of the organic light-emitting diode OLED can be further effectively lengthened.

### Second Embodiment

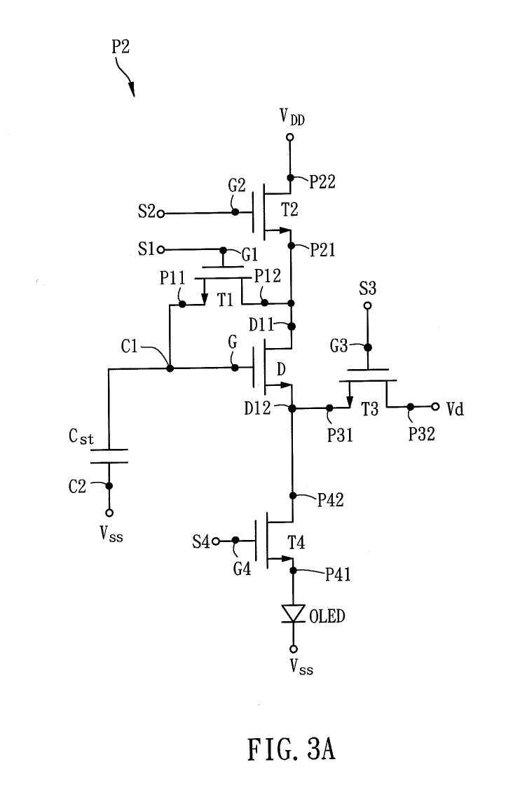

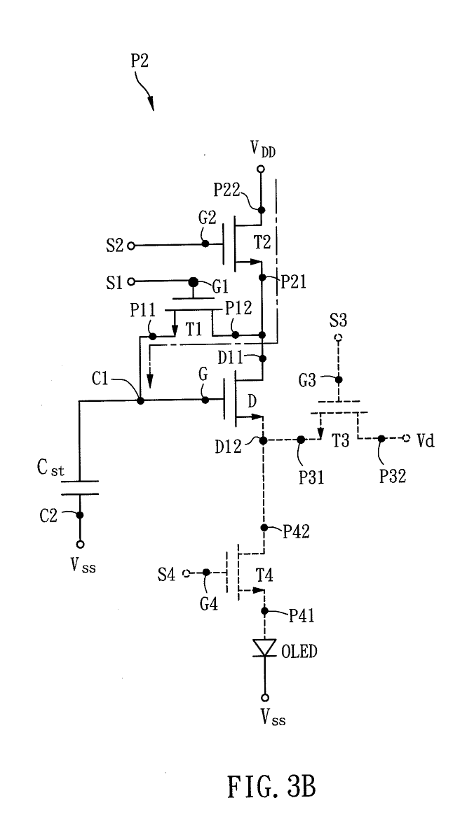

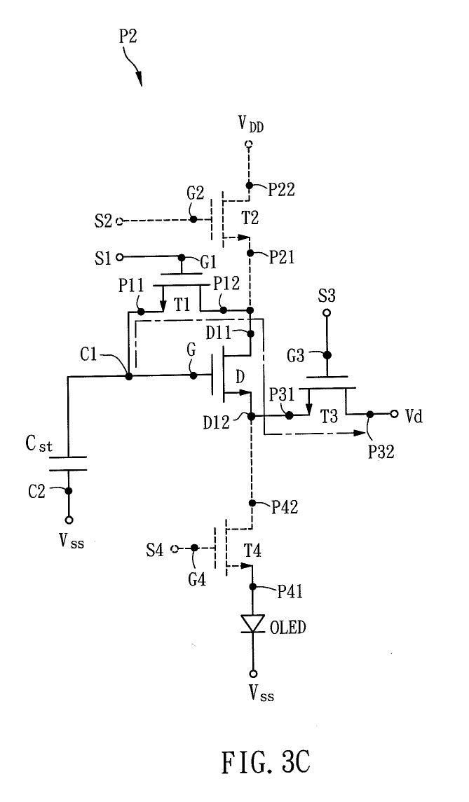

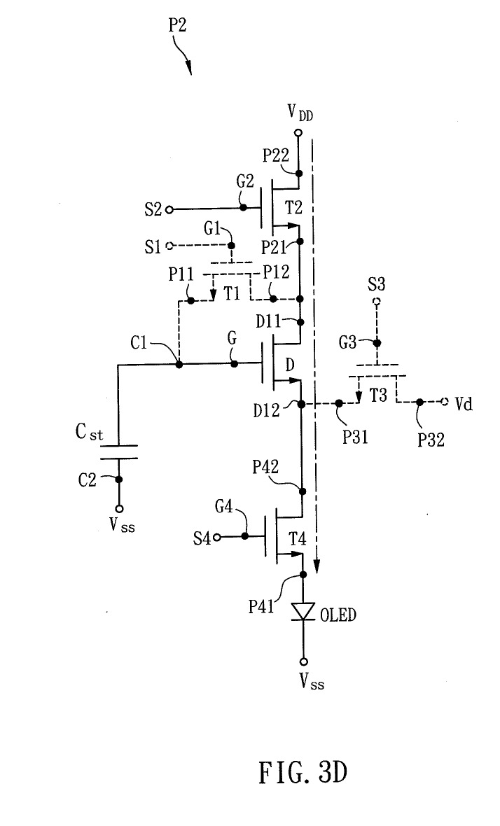

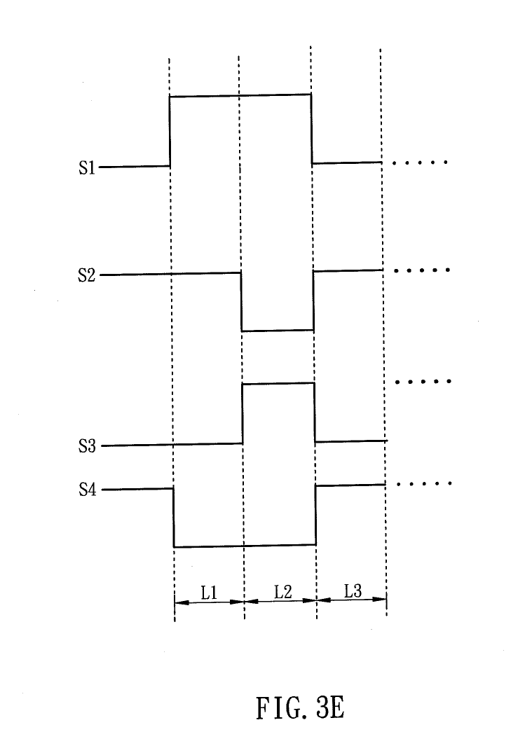

FIG. 3A is a schematic circuit diagram showing a pixel circuit P2 according to a second embodiment of the invention.

Referring to FIG. 3A, the pixel circuit P2 includes an energy storage element Cst, a driving transistor D, a first transistor T1 and a second transistor T2. In addition, the pixel circuit P2 further includes a third transistor T3, a fourth transistor T4 and an organic light-emitting diode OLED.

The gate G of the driving transistor D is electrically connected with the energy storage element Cst. Herein, the energy storage element Cst is a capacitor, the gate G of the driving transistor D is electrically connected with a terminal C1 of the energy storage element Cst, and the other terminal C2 of the energy storage element Cst is connected with a DC bias voltage (either positive or negative).

The first terminal P11 of the first transistor T1 is electrically connected with the terminal C1 of the energy storage element Cst and the gate G of the driving transistor D, and the second terminal P12 of the first transistor T1 is electrically connected with the first terminal D11 of the driving transistor D.

In addition, the first terminal P21 of the second transistor T2 is electrically connected with the first terminal D11 of the driving transistor D and the second terminal P12 of the first transistor T1, and the second terminal P22 of the second transistor T2 is connected with a first voltage V_{DD}.

In addition, the first terminal P31 of the third transistor T3 is electrically connected with the second terminal D12 of the driving transistor D, and the second terminal P32 of the third transistor T3 is connected with the data voltage Vd.

The first terminal P41 of the fourth transistor T4 is electrically connected with the anode of the organic light-emitting diode OLED, and the second terminal P42 of the fourth transistor T4 is electrically connected with the second terminal D12 of the driving transistor D and the first terminal P31 of the third transistor T3. In addition, the cathode of the organic light-emitting diode OLED is connected with a second voltage V_{SS}. Each of the cathode of the organic light-emitting diode OLED and the terminal C2 of the energy storage element Cst may be a DC bias voltage (either positive or negative), so the second voltage V_{SS} is a DC bias voltage.

In this embodiment, the anode of the organic light-emitting diode OLED is electrically connected with the first terminal P41 of the fourth transistor T4, and the cathode of the organic light-emitting diode OLED is connected with the second voltage V_{SS}. In another aspect, however, the anode of the organic light-emitting diode OLED may be connected with the first voltage V_{DD}, and the cathode of the organic light-emitting diode OLED may be electrically connected with the second terminal P22 of the second transistor T2.

In the following, the driving processes of the pixel circuit P2 will be described with reference to FIGS. 3B to 3E, respectively. FIGS. 3B to 3D are schematic illustrations showing that the pixel circuit P2 is driven during different stages, respectively. FIG. 3E is a schematic illustration showing signals for driving the pixel circuit P2. It is to be firstly specified that, in FIGS. 3B to 3D, the transistors indicated by the dashed line portions represent that the transistors are not turned on.

As shown in FIGS. 3B and 3E, during a first stage L1 of driving the pixel circuit P2, the gates G1 and G2 of the first transistor T1 and the second transistor T2 respectively receive a first signal S1 and a second signal S2. Herein, as shown in FIG. 3E, during the first stage L1, the first signal S1 and the second signal S2 are at the high level. Thus, the first transistor T1 and the second transistor T2 can be turned on, as shown by the directions indicated by the dashed line arrows of FIG. 3B. The first voltage V_{DD} (initial voltage) may be at the high level, and the high-level first voltage V_{DD} can charge the terminal C1 of the energy storage element Cst via the second transistor T2 and the first transistor T1, so that the terminal C1 of the energy storage element Cst is charged to the high-level first voltage V_{DD}. The first stage L1 may be referred to as a reset stage of the pixel circuit P2, and the voltage of the terminal C1 of the energy storage element Cst can be reset during the reset stage. In addition, when the terminal C1 of the energy storage element Cst is charged such that the voltage of the gate G of the driving transistor D is increased to the voltage sufficient to turn on the driving transistor D, the driving transistor D is also turned on.

In addition, as shown in FIGS. 3C and 3E, during a second stage L2, the gates G1 and G3 of the first transistor T1 and the third transistor T3 receive the first signal S1 and a third signal S3, respectively. Herein, as shown in FIG. 3E, during the second stage L2, the first signal S1 and the third signal S3 are at the high level, as shown by the direction indicated by the dashed line arrow of FIG. 3C, and the energy storage element Cst can be discharged via the first transistor T1 and the third transistor T3. Because the transistor T3 and the driving transistor D are turned on, the voltage of the second terminal D12 of the driving transistor D is the same as the data voltage Vd, and the voltage difference between the gate G of the driving transistor D and the second terminal D12 of the driving transistor D is the threshold voltage Vth, so the voltage of the terminal C1 of the energy storage element Cst (i.e., the voltage of the gate G of the driving transistor) is discharged to Vd+Vth. The second stage L2 is referred to as the compensation stage of the pixel circuit P2, where the voltage of the gate G of the driving transistor D is discharged to Vd+Vth. It is to be specified that each of the first signal S1, the second signal S2, the third signal S3 and a fourth signal S4 may be a scan signal outputted from the scan driving circuit for driving the display apparatus.

In addition, as shown in FIGS. 3D and 3E, during a third stage L3 of driving the pixel circuit P2, the gates G2 and G4 of the second transistor T2 and the fourth transistor T4 respectively receive the second signal S2 and the fourth signal S4, and the first voltage V_{DD} can drive the organic light-emitting diode OLED to emit light via the second transistor T2, the driving transistor D and the fourth transistor T4. Herein, as shown in FIG. 3E, during the third stage L3, the second signal S2 and the fourth signal S4 are at the high level. Thus, the second transistor T2 and the fourth transistor T4 may be turned on (because the voltage of the gate G of the driving transistor D is Vd+Vth, the driving transistor D is also turned on), as shown by the directions indicated by the dashed line arrows of FIG. 3D, and the first voltage V_{DD} can drive the organic light-emitting diode OLED to emit light via the second transistor T2, the driving transistor D and the fourth transistor T4. Herein, the third stage L3 may be referred to as an emitting stage of the pixel circuit P2, and may also be referred to as a displaying stage. Because the transistor T4 is turned on, the voltage of the second terminal D12 of the driving transistor D is equal to the second voltage Vss plus the V_OLED1 voltage (V_OLED1 is the voltage drop when the organic light-emitting diode OLED is turned on), and the voltage of the gate G of the driving transistor D is still the Vd+Vth of the second stage. So, the voltage difference between the gate and the source (second terminal D12) of the driving transistor D may be referred to as V_{GS}=Vd+Vth−ΔV, wherein ΔV=(Vss+V_OLED1).

Because the driving current I of the organic light-emitting diode OLED is directly proportional to (V_{GS}−Vth)², the driving current I=K×(V_{GS}−Vth)²=K×(Vd+Vth−ΔV−Vth)²=K×(Vd−Vss−V_OLED1)². Thus, it is found that, during the displaying stage, the driving current I only relates to the data voltage Vd and the second voltage Vss, and unrelates to the threshold voltage Vth. Consequently, it is possible to improve the problem of the shift of the threshold voltage Vth caused by the factors of the driving transistor D of the pixel circuit P2, such as different manufacturing processes, different materials, different element properties or the like, and to improve the phenomenon of the nonuniform brightness of the display frame of the OLED display apparatus.

In addition, the first signal S1 and the third signal S3 for driving the pixel circuit P2 may be merged into one driving signal (the first signal S1 in FIG. 3E), so that the two original signal lines may be merged into one signal line, and the aperture ratio loss may also be reduced.

The pixel circuit P2 can improve the problem of the nonuniform brightness of the display frame. In addition, compared with the prior art 6T1C pixel circuit P, which needs to use six transistors, the pixel circuit P2 of the invention only needs five transistors (the driving transistor D and the transistors T1 to T4), which are fewer than the prior art by one transistor, upon layout. Thus, the aperture ratio of the display apparatus can be effectively increased, and the lifetime of the organic light-emitting diode OLED can be further effectively lengthened.

### Third Embodiment

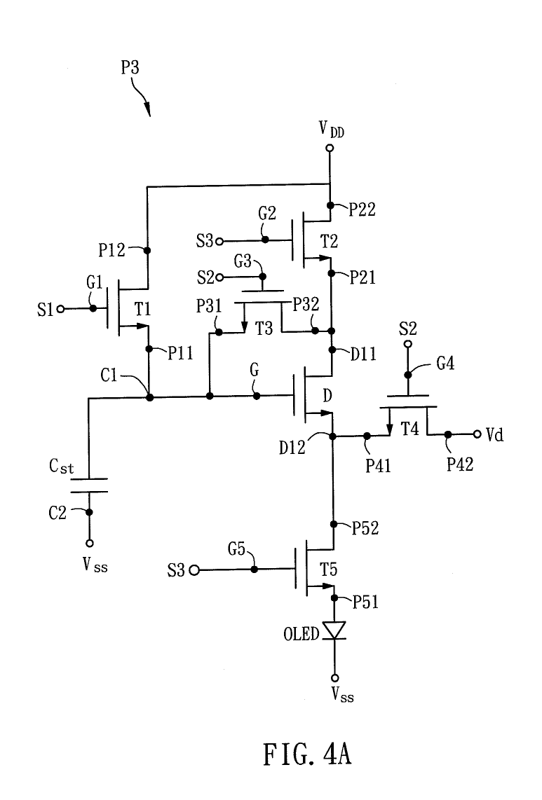

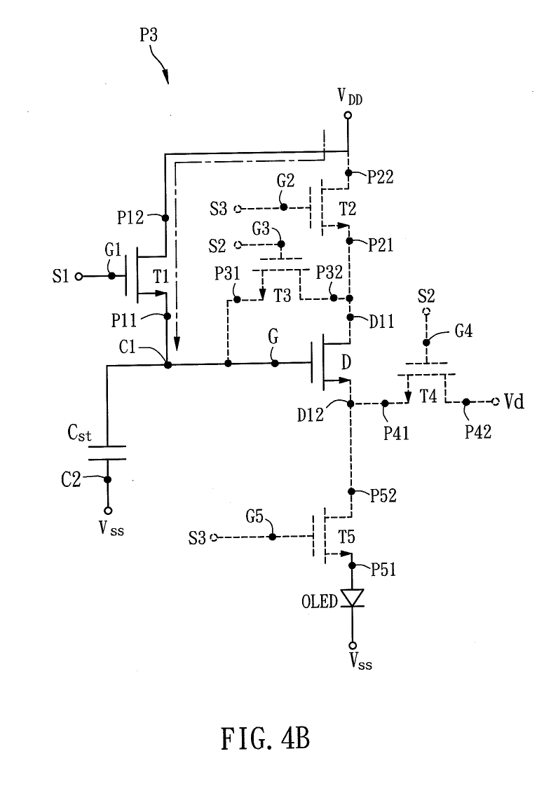

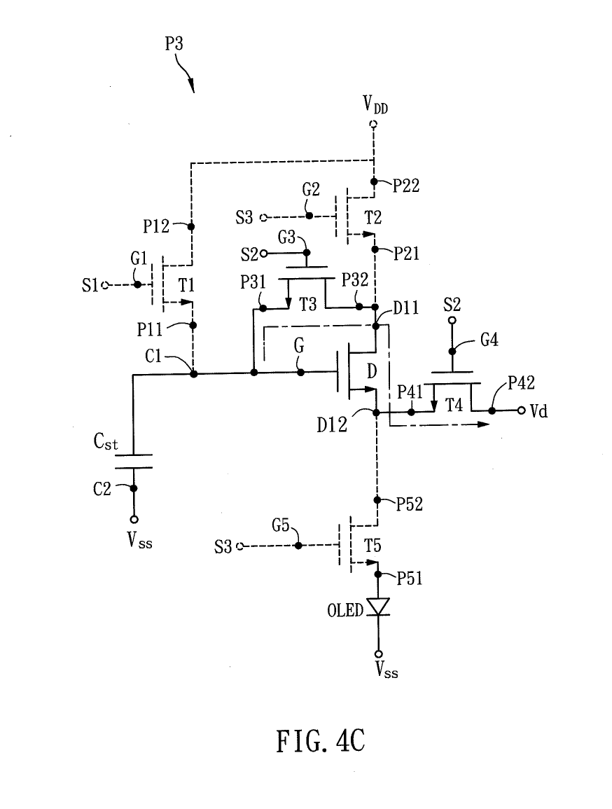

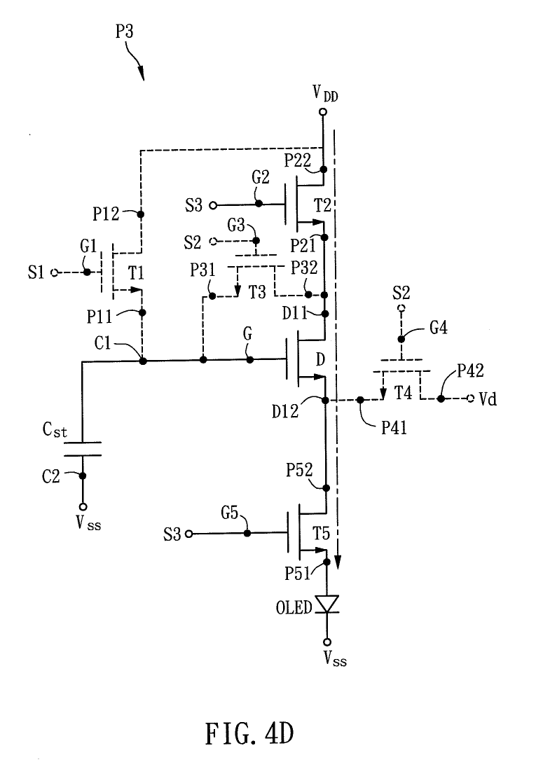

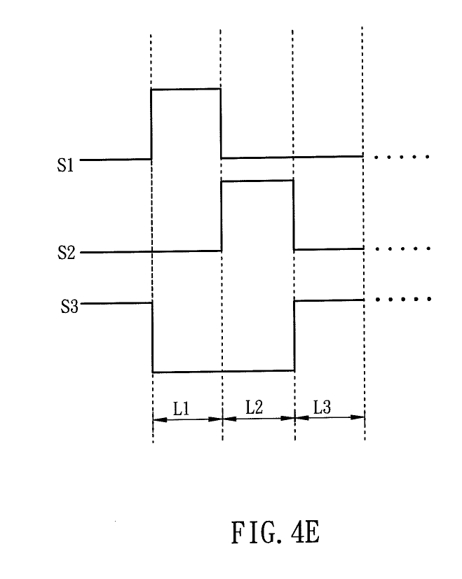

FIG. 4A is a schematic circuit diagram showing a pixel circuit P3 according to a third embodiment of the invention.

Referring to FIG. 4A, the pixel circuit P3 includes an energy storage element Cst, a driving transistor D, a first transistor T1 and a second transistor T2. In addition, the pixel circuit P3 further includes a third transistor T3, a fourth transistor T4, a fifth transistor T5 and an organic light-emitting diode OLED.

The gate G of the driving transistor D is electrically connected with the energy storage element Cst. Herein, the energy storage element Cst is a capacitor, the gate G of the driving transistor D is electrically connected with a terminal C1 of the energy storage element Cst, and the other terminal C2 of the energy storage element Cst is connected with a DC bias voltage (either positive or negative).

The first terminal P11 of the first transistor T1 is electrically connected with the terminal C1 of the energy storage element Cst and the gate G of the driving transistor D, and the second terminal P12 of the first transistor T1 is electrically connected with a first voltage V_{DD} terminal.

In addition, the first terminal P21 of the second transistor T2 is electrically connected with the first terminal D11 of the driving transistor D, and the second terminal P22 of the second transistor T2 is electrically connected with the second terminal P12 of the first transistor T1 and the first voltage V_{DD} terminal.

The first terminal P31 of the third transistor T3 is electrically connected with the terminal C1 of the energy storage element Cst, the gate G of the driving transistor D and the first terminal P11 of the first transistor T1, and the second terminal P32 of the third transistor T3 is electrically connected with the first terminal D11 of the driving transistor D and the first terminal P21 of the second transistor T2.

The first terminal P41 of the fourth transistor T4 is electrically connected with the second terminal D12 of the driving transistor D, and the second terminal P42 of the fourth transistor T4 is electrically connected with a data voltage Vd terminal.

In addition, the first terminal P51 of the fifth transistor T5 is electrically connected with the anode of the organic light-emitting diode OLED, and the second terminal P52 of the fifth transistor T5 is electrically connected with the second terminal D12 of the driving transistor D and the first terminal P41 of the fourth transistor T4. In addition, the cathode of the organic light-emitting diode OLED is electrically connected with a second voltage V_{SS} terminal. The cathode of the organic light-emitting diode OLED and the terminal C2 of the energy storage element Cst may be DC bias voltages (either positive or negative), so the second voltage V_{SS} is a DC bias voltage.

In the following, the driving processes of the pixel circuit P3 will be described with reference to FIGS. 4B to 4E, respectively. FIGS. 4B to 4D are schematic illustrations showing that the pixel circuit P3 is driven during different stages, respectively. FIG. 4E is a schematic illustration showing signals for driving the pixel circuit P3. It is to be firstly specified that, in FIGS. 4B to 4D, the transistors indicated by the dashed line portions represent that the transistors are not turned on.

As shown in FIGS. 4B and 4E, during a first stage L1 of driving the pixel circuit P3, the gate G1 of the first transistor T1 receives a first signal S1, and the first voltage V_{DD} can charge the energy storage element Cst via the first transistor T1. Herein, as shown in FIG. 4E, during the first stage L1, the first signal S1 is at the high level, so the first transistor T1 is turned on, as shown by the direction indicated by the dashed line arrow of FIG. 4B. The first voltage V_{DD} (initial voltage) may be at the high level, and the first voltage V_{DD} can charge the terminal C1 of the energy storage element Cst via the first transistor T1 so that the terminal C1 of the energy storage element Cst is charged to the high-level first voltage V_{DD}. The first stage L1 may be referred to as a reset stage of the pixel circuit P3, and the voltage of the terminal C1 of the energy storage element Cst may be reset during the reset stage. In addition, when the terminal C1 of the energy storage element Cst is charged such that the voltage of the gate G of the driving transistor D is increased to the voltage sufficient to turn on the driving transistor D, the driving transistor D is also turned on.

As shown in FIGS. 4C and 4E, during a second stage L2 of driving the pixel circuit P3, the gates G3 and G4 of the third transistor T3 and the fourth transistor T4 can receive a second signal S2. Herein, as shown in FIG. 4E, during the second stage L2, the second signal S2 is at the high level, as shown by the direction indicated by the dashed line arrow of FIG. 4C, the energy storage element Cst is discharged via the third transistor T3, the driving transistor D and the fourth transistor T4. Because the transistor T4 is turned on, the voltage of the second terminal D12 of the driving transistor D is the same as the data voltage Vd, and the voltage difference between the gate G of the driving transistor D and the second terminal D12 of the driving transistor D is the threshold voltage Vth. Thus, the voltage of the terminal C1 of the energy storage element Cst (i.e., the voltage of the gate G of the driving transistor) is discharged to Vd+Vth. The second stage L2 may be referred to as a compensation stage of the pixel circuit P3, where the voltage of the gate G of the driving transistor D is discharged to Vd+Vth.

In addition, as shown in FIGS. 4D and 4E, during a third stage L3 of driving the pixel circuit P3, the gates G2 and G5 of the second transistor T2 and the fifth transistor T5 receive a third signal S3, and the first voltage V_{DD} can drive the organic light-emitting diode OLED to emit light via the second transistor T2, the driving transistor D and the fifth transistor T5. Herein, as shown in FIG. 4E, during the third stage L3, the third signal S3 may be at the high level. Thus, the second transistor T2 and the fifth transistor T5 may be turned on (because the voltage of the gate G of the driving transistor D is Vd+Vth, the driving transistor D is also turned on), as shown by the arrow directions of FIG. 4D. The data voltage V_{DD} can drive the organic light-emitting diode OLED to emit light via the second transistor T2, the driving transistor D and the fifth transistor T5. Herein, the third stage L3 may be referred to as an emitting stage of the pixel circuit P3, and may also be referred to as a displaying stage. Because the transistor T5 is turned on, the voltage of the second terminal D12 of the driving transistor D is equal to the second voltage Vss plus the V_OLED1 voltage (V_OLED1 is the voltage drop when the organic light-emitting diode OLED is turned on), and the voltage of the gate G of the driving transistor D is still Vd+Vth of the second stage. So, the voltage difference between the gate G and the source (D12) of the driving transistor D is referred to as V_{GS}=Vd+Vth−ΔV, wherein ΔV=(Vss+V_OLED1).

Because the driving current I of the organic light-emitting diode OLED is directly proportional to (V_{GS}−Vth)², the driving current I=K×(V_{GS}−Vth)²=K×(Vd+Vth−ΔV−Vth)²=K×(Vd−Vss−V_OLED1)². Thus, it is found that, during the displaying stage, the driving current I only relates to the data voltage Vd and the second voltage V_{SS}, and unrelates to the threshold voltage Vth. Consequently, it is possible to improve the problem of the shift of the threshold voltage Vth caused by the factors of the driving transistor D of the pixel circuit P3, such as different manufacturing processes, different materials, different element properties or the like, and to improve the phenomenon of the nonuniform brightness of the display frame of the OLED display apparatus.

The pixel circuit P3 can improve the problem of the nonuniform brightness of the display frame. In addition, compared with the prior art 6T1C pixel circuit P, which needs to use four signal lines, the pixel circuit P3 of the invention only needs three signal lines (the lines for the first signal S1, the second signal S2 and the third signal S3), which are fewer than the prior art by one signal line, upon layout. Thus, the aperture ratio of the display apparatus can be effectively increased, and the lifetime of the organic light-emitting diode OLED can be further effectively lengthened.

In addition, it is to be further specified that the driving transistors D of the pixel circuits P1 to P3 and the first to fifth transistors T1 to T5 are N-type metal-oxide semiconductor (NMOS) transistors. In other embodiment, the driving transistors D of the pixel circuits P1 to P3 and the first to fifth transistors T1 to T5 may also be P-type metal-oxide semiconductor (PMOS) transistors as long as the sources and the drains of the first to fifth transistors T1 to T5 are exchanged, and the voltage levels of the first signal S1, the second signal S2, the third signal S3 and the fourth signal S4 are exchanged (i.e., the high level becomes the low level, and the low level becomes the high level).

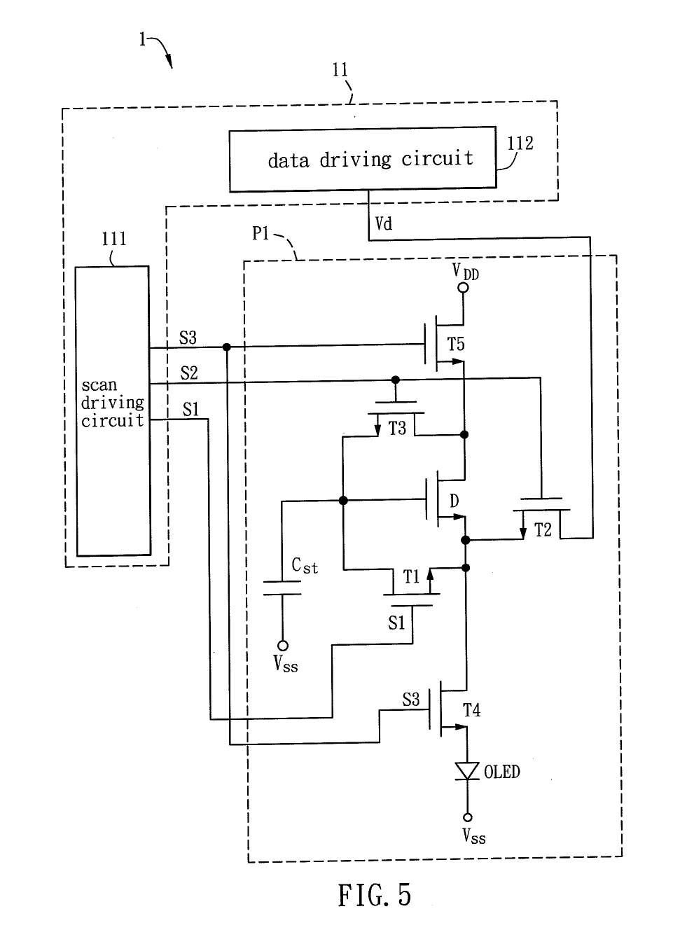

FIG. 5 is a schematic illustration showing a display apparatus 1 according to a preferred embodiment of the invention.

Referring to FIG. 5, the display apparatus 1 includes a driving circuit 11 and at least one pixel circuit P1. Herein, the display apparatus 1 has a plurality of pixels P1 (not shown).

The driving circuit 11 may have at least one scan line and at least one data line, and may at least output a data voltage Vd, a first signal S1, a second signal S2 and a third signal S3. The driving circuit 11 may have a scan driving circuit 111 and a data driving circuit 112, the scan driving circuit 111 may output the first signal S1, the second signal S2 and the third signal S3, which may be scan signals for driving the pixel circuit P1. In addition, the data driving circuit 112 may output the data voltage Vd, which may be a gray scale voltage for driving the pixel circuit P1.

The pixel circuit P1 includes an energy storage element Cst, a driving transistor D, a first transistor T1 and a second transistor T2. In addition, the pixel circuit P1 may further include a third transistor T3, a fourth transistor T4, a fifth transistor T5 and an organic light-emitting diode OLED. The elements of the pixel circuit P1 and connection relationships therebetween as well as the driving process thereof have been described in the first embodiment, so detailed descriptions thereof will be omitted.

Thus, during the displaying stage (i.e., the third stage L3, emitting stage) of the display apparatus 1, the driving current I for driving the organic light-emitting diode OLED only relates to the data voltage Vd and the second voltage V_{SS}, and unrelates to the threshold voltage Vth. Consequently, it is possible to improve the problem of the shift of the threshold voltage Vth caused by the factors of the driving transistor D of the pixel circuit P1, such as different manufacturing processes, different materials, different element properties or the like, and to improve the phenomenon of the nonuniform brightness of the display frame of the OLED display apparatus 1.

It is to be reminded that the pixel circuit P1 may also be replaced by the pixel circuit P2 of the second embodiment and the pixel circuit P3 of the third embodiment, and the aperture ratio of the display apparatus still can be effectively enhanced while the lifetime of the organic light-emitting diode OLED can be still lengthened. The pixel circuits P2 and P3 of the second and third embodiments have been described hereinabove, so detailed descriptions thereof will be omitted.

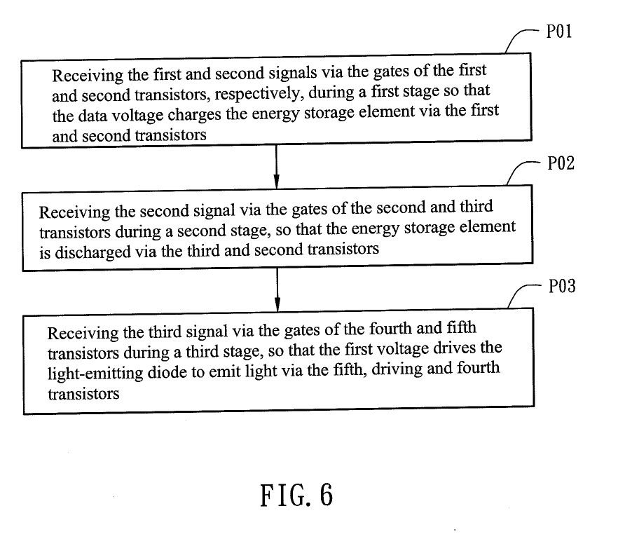

FIG. 6 is a schematic flow chart showing a driving method of the invention. Referring to FIG. 6, the driving method of the invention is applied with the display apparatus 1 and the pixel circuit P1 thereof, which have been described hereinabove and will not be described herein.

The driving method may include the step P01 of receiving the first signal S1 and the second signal S2 via the gates G1 and G2 of the first transistor T1 and the second transistor T2, respectively, during a first stage L1 such that the data voltage Vd can charge the energy storage element Cst via the first transistor T1 and the second transistor T2.

In addition, the driving method may further include the step P02 of receiving the second signal S2 via the gates G2 and G3 of the second transistor T2 and the third transistor T3 during a second stage L2 such that the energy storage element Cst is discharged via the third transistor T3 and the second transistor T2.

In addition, the driving method may further include the step P03 of receiving the third signal S3 via the gates G4 and G5 of the fourth transistor T4 and the fifth transistor T5 during a third stage L3 such that the first voltage V_{DD} drives the organic light-emitting diode OLED to emit light via the fifth transistor T5, the driving transistor D and the fourth transistor T4. In addition, the above-mentioned driving method and the technological characteristics thereof have been described in the first embodiment, and detailed descriptions thereof will be omitted.

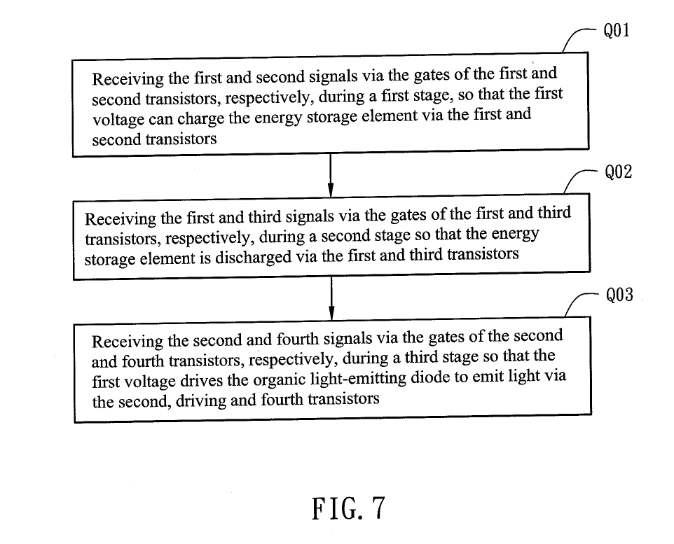

FIG. 7 is a schematic flow chart showing another driving method of the invention. Referring to FIG. 7, the another driving method is applied with the display apparatus 1 and the pixel circuit P2 thereof, which have been described hereinabove and will not be described herein.

The driving method may include the step Q01 of receiving the first signal S1 and the second signal S2 via the gates G1 and G2 of the first transistor T1 and the second transistor T2, respectively, during a first stage L1 such that the first voltage V_{DD} can charge the energy storage element Cst via the first transistor T1 and second transistor T2.

In addition, the driving method may further include the step Q02 of receiving the first signal S1 and the third signal S3 via the gates G1 and G3 of the first transistor T1 and the third transistor T3, respectively, during a second stage L2 such that the energy storage element Cst is discharged via the first transistor T1 and the third transistor T3.

In addition, the driving method may further include the step Q03 of receiving the second signal S2 and the fourth signal S4 via the gates G2 and G4 of the second transistor T2 and the fourth transistor T4, respectively, during a third stage L3 such that the first voltage V_{DD} drives the organic light-emitting diode OLED to emit light via the second transistor T2, the driving transistor D and the fourth transistor T4. In addition, the technological characteristics thereof of the another driving method of the invention have been described in the second embodiment, and detailed descriptions thereof will be omitted.

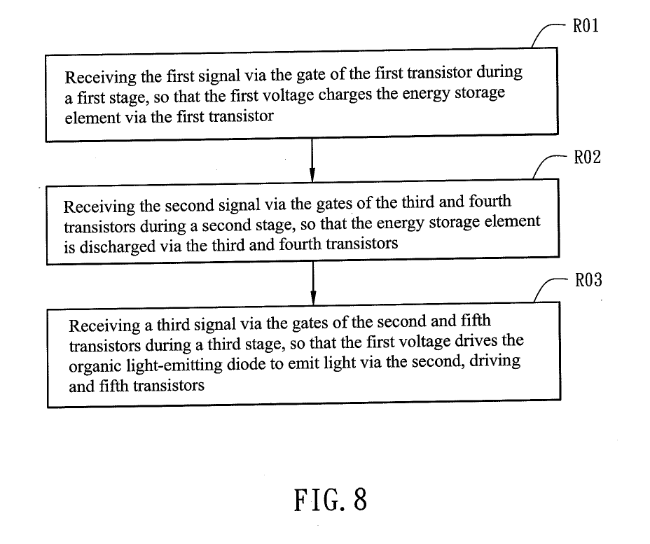

Please refer to FIGS. 4A and 8 simultaneously. FIG. 8 is a schematic flow chart showing still another driving method of the invention. Referring to FIGS. 4A and 8, the driving method is applied with the display apparatus 1 and the pixel circuit P3 thereof, which have been described hereinabove and will not be described herein.

The driving method may include the step R01 of receiving the first signal S1 via the gate G1 of the first transistor T1 during a first stage L1 such that the first voltage V_{DD} charges the energy storage element Cst via the first transistor T1.

In addition, the driving method may further include the step R02 of receiving the second signal S2 via the gates G3 and G4 of the third transistor T3 and the fourth transistor T4 during a second stage L2 such that the energy storage element Cst is discharged via the third transistor T3 and the fourth transistor T4.

In addition, the driving method may further include the step R03 of receiving the third signal S3 via the gates G2 and G5 of the second transistor T2 and the fifth transistor T5 during a third stage L3 such that the first voltage V_{DD} drives the organic light-emitting diode OLED to emit light via the second transistor T2, the driving transistor D and the fifth transistor T5. In addition, the technological characteristics thereof of the still another driving method of the invention have been described in the second embodiment, and detailed descriptions thereof will be omitted.

In summary, the pixel circuit, the display apparatus and the driving method of the invention have the following features. During a first stage, the gates of the first transistor and the second transistor receive a first signal and a second signal, respectively, and the data voltage or the first voltage can charge the energy storage element via the first transistor and the second transistor. Alternatively, during a first stage, the gate of the first transistor can receive a first signal, and the first voltage can charge the energy storage element via the first transistor. Therefore, it is possible to make the driving current for driving the organic light-emitting diode of the pixel circuit only relate to the data voltage and the second voltage, but unrelate to the threshold voltage of the driving transistor during the emitting stage (i.e., the displaying stage) of the display apparatus. Consequently, it is possible to improve the problem of the shift of the threshold voltage caused by the factors of the driving transistor of the pixel circuit, such as different manufacturing processes, different materials, different element properties or the like, and to improve the phenomenon of the nonuniform brightness of the display frame of the OLED display apparatus. In addition, compared with the prior art pixel circuit, the number of signal lines or the number of transistors used in the pixel circuit of the invention is smaller than that of the prior art by one, so that the aperture ratio of the display apparatus can be effectively enhanced, and the lifetime of the organic light-emitting diode can be further lengthened.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A pixel circuit, comprising:
an energy storage element;
a driving transistor, wherein a gate of the driving transistor is electrically connected with the energy storage element;
a first transistor, wherein a first terminal of the first transistor is electrically connected with the energy storage element and the gate of the driving transistor, and a second terminal of the first transistor is electrically connected with a first terminal of the driving transistor; and
a second transistor, wherein a first terminal of the second transistor is electrically connected with the first terminal of the driving transistor and the second terminal of the first transistor, and a second terminal of the second transistor is connected with a data voltage or a first voltage,
wherein during a first stage, gates of the first transistor and the second transistor receive a first signal and a second signal, respectively, and the data voltage or the first voltage charges the energy storage element via the first transistor and the second transistor.

2. The pixel circuit according to claim 1, further comprising:
a third transistor, wherein a first terminal of the third transistor is electrically connected with the energy storage element, the gate of the driving transistor and the first terminal of the first transistor, and a second terminal of the third transistor is electrically connected with a second terminal of the driving transistor.

3. The pixel circuit according to claim 2, wherein during a second stage, the gate of the second transistor and a gate of the third transistor receive the second signal, and the energy storage element is discharged via the third transistor and the second transistor.

4. The pixel circuit according to claim 2, further comprising:
an organic light-emitting diode having a cathode connected with a second voltage;
a fourth transistor, wherein a first terminal of the fourth transistor is electrically connected with an anode of the organic light-emitting diode, and a second terminal of the fourth transistor is electrically connected with the first terminal of the driving transistor, the second terminal of the first transistor and the first terminal of the second transistor; and
a fifth transistor, wherein a first terminal of the fifth transistor is electrically connected with the second terminal of the driving transistor and the second terminal of the third transistor, and a second terminal of the fifth transistor is connected with the first voltage.

5. The pixel circuit according to claim 4, wherein during a third stage, gates of the fourth transistor and the fifth transistor receive a third signal, and the first voltage drives the organic light-emitting diode to emit light via the fifth transistor, the driving transistor and the fourth transistor.

6. The pixel circuit according to claim 1, further comprising:
a third transistor, wherein a first terminal of the third transistor is electrically connected with a second terminal of the driving transistor, and a second terminal of the third transistor is connected with the data voltage.

7. The pixel circuit according to claim 6, wherein during a second stage, the gate of the first transistor and a gate of the third transistor receive the first signal and a third signal, respectively, and the energy storage element is discharged via the first transistor and the third transistor.

8. The pixel circuit according to claim 6, further comprising:
an organic light-emitting diode having a cathode connected with a second voltage; and
a fourth transistor, wherein a first terminal of the fourth transistor is electrically connected with an anode of the organic light-emitting diode, and a second terminal of the fourth transistor is electrically connected with the second terminal of the driving transistor and the first terminal of the third transistor.

9. The pixel circuit according to claim 8, wherein during a third stage, the gate of the second transistor and a gate of the fourth transistor receive the second signal and a fourth signal, respectively, and the first voltage drives the organic light-emitting diode to emit light via the second transistor, the driving transistor and the fourth transistor.

10. A pixel circuit, comprising:
an energy storage element;
a driving transistor having a gate electrically connected with the energy storage element;
a first transistor, wherein a first terminal of the first transistor is electrically connected with the energy storage element and the gate of the driving transistor, and a second terminal of the first transistor is connected with a first voltage; and
a second transistor, wherein a first terminal of the second transistor is electrically connected with a first terminal of the driving transistor, and a second terminal of the second transistor is connected with the second terminal of the first transistor and the first voltage,
wherein during a first stage, a gate of the first transistor receives a first signal, and the first voltage charges the energy storage element via the first transistor.

11. The pixel circuit according to claim 10, further comprising:
a third transistor, wherein a first terminal of the third transistor is electrically connected with a terminal of the energy storage element, the gate of the driving transistor and the first terminal of the first transistor, and a second terminal of the third transistor is connected with the first terminal of the driving transistor and the first terminal of the second transistor; and
a fourth transistor, wherein a first terminal of the fourth transistor is electrically connected with a second terminal of the driving transistor, and a second terminal of the fourth transistor is connected with a data voltage.

12. The pixel circuit according to claim 11, wherein during a second stage, a gate of the third transistor and a gate of the fourth transistor receive a second signal, and the energy storage element is discharged via the third transistor and the fourth transistor.

13. The pixel circuit according to claim 11, further comprising:
an organic light-emitting diode having a cathode connected with a second voltage; and
a fifth transistor, wherein a first terminal of the fifth transistor is electrically connected with an anode of the organic light-emitting diode, and a second terminal of the fifth transistor is electrically connected with the second terminal of the driving transistor and the first terminal of the fourth transistor.

14. The pixel circuit according to claim 13, wherein during a third stage, gates of the second transistor and the fifth transistor receive a third signal, and the first voltage drives the organic light-emitting diode to emit light via the second transistor, the driving transistor and the fifth transistor.

15. A driving method applied with a display apparatus, which comprises a driving circuit and at least one pixel circuit, wherein the driving circuit has at least one scan line and at least one data line and at least outputs a data voltage, a first signal and a second signal; the first signal and the second signal are scan signals outputted from the scan line, respectively; the pixel circuit has an energy storage element, a driving transistor, a first transistor and a second transistor; a gate of the driving transistor is electrically connected with one terminal of the energy storage element, a first terminal of the first transistor is electrically connected with the terminal of the energy storage element and the gate of the driving transistor; a second terminal of the first transistor is electrically connected with a first terminal of the driving transistor, a first terminal of the second transistor is electrically connected with the first terminal of the driving transistor and the second terminal of the first transistor; a second terminal of the second transistor is connected with the data voltage or a first voltage; and the driving method comprises:
receiving the first signal and the second signal via gates of the first transistor and the second transistor, respectively, during a first stage so that the data voltage or the first voltage charges the energy storage element via the first transistor and the second transistor.

16. The driving method according to claim 15, wherein the pixel circuit further comprises a third transistor, a first terminal of the third transistor is electrically connected with the terminal of the energy storage element, the gate of the driving transistor and the first terminal of the first transistor, a second terminal of the third transistor is electrically connected with a second terminal of the driving transistor, and the driving method further comprises:
receiving the second signal via the gate of the second transistor and a gate of the third transistor during a second stage, so that the energy storage element is discharged via the third transistor and the second transistor.

17. The driving method according to claim 16, wherein the pixel circuit further comprises an organic light-emitting diode, a fourth transistor and a fifth transistor, a cathode of the organic light-emitting diode is connected with a second voltage, a first terminal of the fourth transistor is electrically connected with an anode of the organic light-emitting diode, a second terminal of the fourth transistor is electrically connected with the first terminal of the driving transistor, the second terminal of the first transistor and the first terminal of the second transistor, a first terminal of the fifth transistor is electrically connected with the second terminal of the driving transistor and a second terminal of the third transistor, a second terminal of the fifth transistor is connected with the first voltage, and the driving method further comprises:
receiving a third signal via gates of the fourth transistor and the fifth transistor during a third stage, so that the first voltage drives the organic light-emitting diode to emit light via the fifth transistor, the driving transistor and the fourth transistor.

18. The driving method according to claim 15, wherein the pixel circuit further comprises a third transistor, a first terminal of the third transistor is electrically connected with a second terminal of the driving transistor, a second terminal of the third transistor is connected with the data voltage, and the driving method further comprises:
receiving the first signal and a third signal via the gate of the first transistor and a gate of the third transistor, respectively, during a second stage, so that the energy storage element is discharged via the first transistor and the third transistor.

19. The driving method according to claim 18, wherein the pixel circuit further comprises an organic light-emitting diode and a fourth transistor, a cathode of the organic light-emitting diode is connected with a second voltage, a first terminal of the fourth transistor is electrically connected with an anode of the organic light-emitting diode, a second terminal of the fourth transistor is electrically connected with the second terminal of the driving transistor and the first terminal of the third transistor, and the driving method further comprises:
receiving the second signal and a fourth signal via the gate of the second transistor and a gate of the fourth transistor, respectively, during a third stage, so that the first voltage drives the organic light-emitting diode to emit light via the second transistor, the driving transistor and fourth transistor.
